(19) United States
(12) Patent Application Publication
(10) Pub. No.: US 2005/0251457 A1
(43) Pub. Date: Nov. 10, 2005

(54) Self-propelled cleaner

(75) Inventor: Yoshihiro Kashiwagi, Osaka (JP)

Correspondence Address: Yokoi & Co., U.S.A., Inc., 13700 Marina Pointe Drive #1512, Marina Del Ray, CA, 90292, US

(73) Assignee: Funai Electric Co., Ltd., Osaka (JP)

(21) Appl. No.: 11/105,107

(22) Filed: Apr. 13, 2005

(30) Foreign Application Priority Data
Apr. 15, 2004 (JP) JP2004-120606

(51) Int. Cl. G06F 17/60

(52) U.S. Cl. 705/26

(57) ABSTRACT

A conventional automatic ordering system requires stock management, so it is useless unless it is used on the assumption that stock is in hand and managed. In a self-propelled cleaner according to this invention, based on the results of a series of self-diagnosis steps (step S400 and subsequent steps) and the cumulative duration of use and the cumulative traveled distance as accumulated during daily cleaning operations (step 270), the necessity for an order for a replacement is judged (steps S431 and S427 to S478) and if ordering is necessary, the user is asked to decide whether to approve ordering (steps S482 and S484) and through a wireless LAN, an order is placed and payment is made by prepaid electronic money (steps S488 and S490). This automatic ordering system can be used conveniently in the home where consumable stock management is impossible.

### BACKGROUND OF THE INVENTION

1. Field of the invention

This invention relates to a self-propelled cleaner having a body with a cleaning mechanism and a drive mechanism capable of steering and driving the cleaner.

2. Description of the prior art

Conventional robot systems which manage consumable stock and automatically place an order before the stock is exhausted (as disclosed in JP-A No. 344467/2001, JP-A No. 84953/2003 and JP-A No. 280722/2003) have been known.

The above conventional automatic ordering systems require stock management and cannot be used when users are not supposed to carry stock.

### SUMMARY OF THE INVENTION

This invention has been made in view of the abovementioned problem and provides a self-propelled cleaner that automatically orders consumables regardless of stock.

According to one aspect of this invention, a self-propelled cleaner has a body with a cleaning mechanism, and a drive mechanism capable of steering and driving the cleaner. It includes: a wireless LAN communication device which can transmit information to the outside and receive information from the outside through a wireless LAN; a self-diagnosis processor which conducts self-checks; and a consumables ordering control processor which determines, based on the results of self-diagnosis, which consumables should be replaced and makes the wireless LAN communication device place an order.

As described above, the self-propelled cleaner has a drive mechanism capable of steering and driving the cleaner and can perform cleaning while traveling by self-propulsion. Also, the self-diagnosis processor carries out self-checks and the consumables ordering control processor determines, based on the results of self-diagnosis, which consumables should be replaced and places an order through the wireless LAN communication device communicate with the outside.

In other words, this system can not only perform consumable stock management but also check its own functions, determines consumables to be replaced, based on the results of self-diagnosis, and automatically place an order.

Automatic ordering often involves a cost factor and depending on the situation, the user may not want to place an order. According to another aspect of the invention, the ordering control processor asks the user to decide whether to order or not before ordering through the wireless LAN communication device.

In the system constructed as above, since the system asks the user to decide whether to order or not before ordering, there is no possibility that an order might be placed automatically though the user does not wish to order.

According to another aspect of the invention, the body has a rechargeable battery as a consumable component to be self-checked; the self-diagnosis processor diagnoses the condition of the rechargeable battery; and if the self-diagnosis processor finds based on the results of self-diagnosis that the rechargeable battery is exhausted, the consumables ordering control processor makes the wireless LAN communication device order a replacement for the battery.

Since the rechargeable battery's condition is self-checked, based on the results of self-diagnosis, a new battery can be ordered before the old battery becomes unusable.

According to another aspect of the invention, the cleaning mechanism of the body has brushes for cleaning; the self-diagnosis processor can suggest wear of a brush; and if the self-diagnosis processor suggests wear of the brushes based on the results of self-diagnosis, the consumables ordering control processor makes the wireless LAN communication device order replacements for the brushes.

Therefore, new brushes can be ordered before the old brushes become unusable.

It is not always easy to evaluate wear of the brushes. According to another aspect of the invention, the self-diagnosis processor measures with a timer and accumulates the duration of use of the brushes and suggests wear of the brushes when a prescribed cumulative duration of use is exceeded.

In short, wear of the brushes is evaluated based on the cumulative duration of use.

According to another aspect of the invention, the self-diagnosis processor accumulates the distances traveled during use of the brushes and suggests wear of the brushes when a prescribed cumulative traveled distance is exceeded.

According to another aspect of the invention, the drive mechanism is a replaceable unit and, if the self-diagnosis processor finds based on the results of self-diagnosis that the drive mechanism is out of order, the ordering control processor orders a replacement for the drive mechanism as a unit.

In the self-propelled cleaner, it is convenient for the drive mechanism for traveling to use a unit which can be easily replaced as it wears. A replacement for it can be ordered based on the results of self-diagnosis.

Even when an order is automatically placed before a consumable component becomes completely unusable, if it takes time for the supplier to confirm that payment for the order is guaranteed, shipment may be delayed and the component may become no longer usable before arrival of the order.

Hence, according to another aspect of the invention, the ordering control processor allows payment for the order by prepaid card electronic money.

Prepaid electronic money guarantees payment as far as the balance is enough to make the payment, so the supplier can quickly ship the order with no time required for confirmation.

The cleaning mechanism incorporated in the body may be of the suction-type or brush-type or combination-type.

The drive mechanism capable of steering and driving the cleaner may be embodied in various forms. One example is a drive mechanism having drive wheels at the right and left sides of the body which can be controlled individually. In this case, the drive mechanism enables the cleaner to go forward or backward, or turn to the right (clockwise) or to the left (counterclockwise), or spin on the same spot by controlling individually the drive wheels provided at the right and left sides of the body. Apparently, auxiliary wheels maybe provided, for example, before and behind the drive wheels. Furthermore, endless belts may be used instead of drive wheels.

The number of wheels in the drive mechanism is not limited to two; it may be four, six or more.

As one concrete example of the above system, according to another aspect of the invention, a self-propelled cleaner has a body with a cleaning mechanism with a rechargeable battery for cleaning with brushes, and a drive mechanism with replaceable drive wheel units at the left and right sides of the body which can be individually controlled for steering and driving the cleaner. It includes:
a wireless LAN communication device which can transmit information to the outside and receive information from the outside through a wireless LAN;
a self-diagnosis processor which conducts self-checks including judgment about the condition of the rechargeable battery and judgment about the condition of the brushes based on the cumulative duration of use of the brushes and the cumulative distance traveled during their use; and
a consumables ordering control processor which checks the rechargeable battery for exhaustion and the brushes for wear, based on the cumulative duration of use of the brushes and the cumulative traveled distance, and checks the drive wheels for abnormality and determines which consumables should be replaced, asks the user to decide whether to order or not and makes the wireless LAN communication device place an order.

As described above, the self-propelled cleaner has a rechargeable battery as a driving energy source and propels itself for cleaning by means of a drive mechanism with replaceable drive wheel units. The cleaning mechanism performs cleaning using brushes. The self-propelled cleaner has a self-diagnosis processor to carry out self-checks including judgment about the condition of the rechargeable battery and judgment about the condition of the brushes based on the cumulative duration of use of the brushes and the cumulative distance traveled during their use. The consumables ordering control processor checks, based on the results of self-diagnosis, the rechargeable battery for exhaustion, and the brushes for wear, based on the cumulative duration of use of the brushes and the cumulative traveled distance, and checks the drive wheels for abnormality and determines which consumables should be replaced. If a certain consumable component should be replaced, it asks the user to decide whether to order or not and then orders a replacement for the component through the wireless LAN communication device which can receive information from the outside and transmit information to the outside.

This means that the self-propelled cleaner decides the necessity for replacement of consumables based on the results of self-diagnosis and automatically orders consumables as needed, eliminating the need for stock management.

### BRIEF DESCRIPTION OF THE DRAWINGS

FIG. 1 is a block diagram schematically showing the construction of a self-propelled cleaner according to this invention;

FIG. 2 is a more detailed block diagram of the self-propelled cleaner;

FIG. 3 is a block diagram of an AF passive sensor unit;

FIG. 4 illustrates the position of a floor relative to the AF passive sensor unit and how ranging distance changes when the AF passive sensor unit is oriented downward obliquely toward the floor;

FIG. 5 illustrates the ranging distance in the imaging range when an AF passive sensor for the immediate vicinity is oriented downward obliquely toward the floor;

FIG. 6 illustrates the positions and ranging distances of individual AF passive sensors;

FIG. 7 is a flowchart showing a traveling control process;

FIG. 8 is a flowchart showing a cleaning traveling process;

FIG. 9 shows a travel route in a room;

FIG. 10 is a flowchart showing a self-diagnosis process;

FIG. 11 is a diagnosis result flag table;

FIG. 12 is a flowchart showing an abnormality warning process;

FIG. 13 illustrates a liquid crystal display panel for selection of an abnormality warning method;

FIG. 14 illustrates a liquid crystal display panel for selection of a message type;

FIG. 15 shows the contents of a table which stores messages by type;

FIG. 16 is a flowchart showing a consumables ordering process;

FIG. 17 illustrates a display window which confirms whether to order or not; and

FIG. 18 illustrates a display window which enables the user to enter a verification code for prepaid electronic money.

### DESCRIPTION OF THE PREFERRED EMBODIMENTS

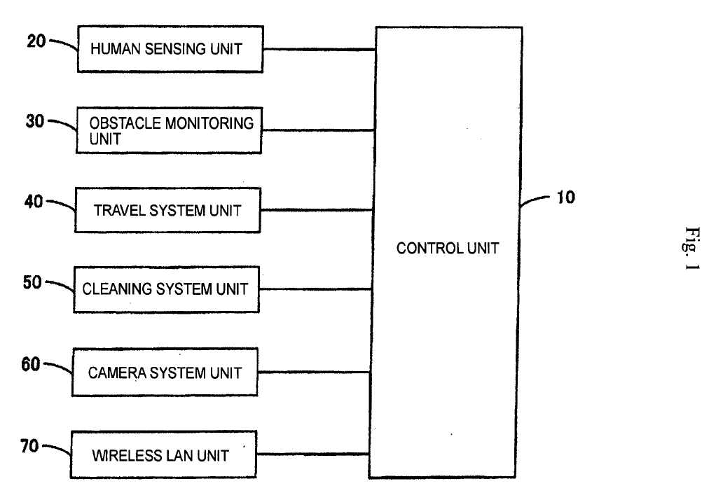

As shown in FIG. 1, according to this invention, the cleaner includes a control unit 10 to control individual units; a human sensing unit 20 to detect a human or humans around the cleaner; an obstacle monitoring unit 30 to detect an obstacle or obstacles around the cleaner; a travel system unit 40 for traveling; a cleaning system unit 50 for cleaning; a camera system unit 60 to take a photo of a given area; and a wireless LAN unit 70 for wireless connection to a LAN. The body BD of the cleaner has a low profile and is almost cylindrical.

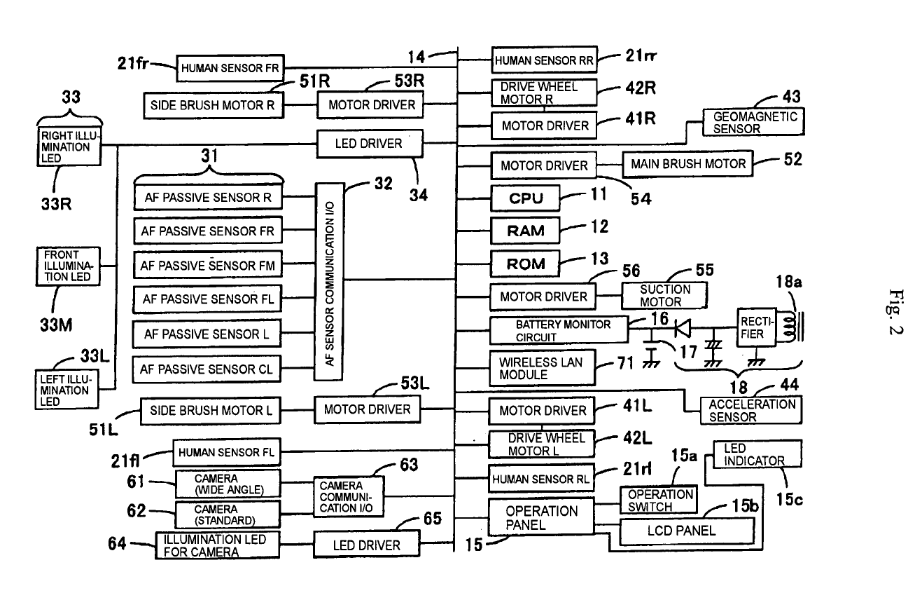

As shown in FIG. 2, a block diagram showing the electrical system configuration for the individual units, a CPU 11, a ROM 13, and a RAM 12 are interconnected via a bus 14 to constitute a control unit 10. The CPU 11 performs various control tasks using the RAM 12 as a work area according to a control program stored in the ROM 13 and various parameter tables. The control program will be described later in detail.

The bus 14 is equipped with an operation panel 15 on which various types of operation switches 15a, a liquid crystal display panel 15b, and LED indicators 15c are provided. Although the liquid crystal display panel is a monochrome liquid crystal panel with a multi-tone display function, a color liquid crystal panel or the like may also be used.

This self-propelled cleaner has a battery 17 and allows the CPU 11 to monitor the remaining amount of the battery 17 through a battery monitor circuit 16. The battery 17 is equipped with a charge circuit 18 that charges the battery with electric power supplied in a non-contact manner through an induction coil 18a. The battery monitor circuit 16 mainly monitors the voltage of the battery 17 to detect its remaining amount. The human sensing unit 20 consists of four human sensors 21 (21fr, 21rr, 21f1, 21r1), two of which are disposed obliquely at the left and right sides of the front of the body and the other two at the left and right sides of the rear of the body. Each human sensor 21 has an infrared light-receiving sensor that detects the presence of a human body based on the amount of infrared light received. When the human sensor detects an irradiated object which changes the amount of infrared light received, the CPU 11 obtains the result of detection by the human sensor 21 via the bus 14 to change the status for output. In other words, the CPU 11 obtains the status of each of the human sensors 21fr, 21rr, 21f1, and 21r1 at each predetermined time and detects the presence of a human body in front of the human sensor 21fr, 21rr, 21f1, or 21rl by a change in the status.

Although the human sensors described above detect the presence of a human body based on changes in the amount of infrared light, the human sensors are not limited to this type. For example, if the CPU's processing capability is increased, it is possible to take a color image of a target area, identify a skin-colored area that is characteristic of a human body and detect the presence of a human body based on the size of the area and/or change. Obviously a motion sensor which takes monochrome images and detects a moving object based on change in images may be used instead.

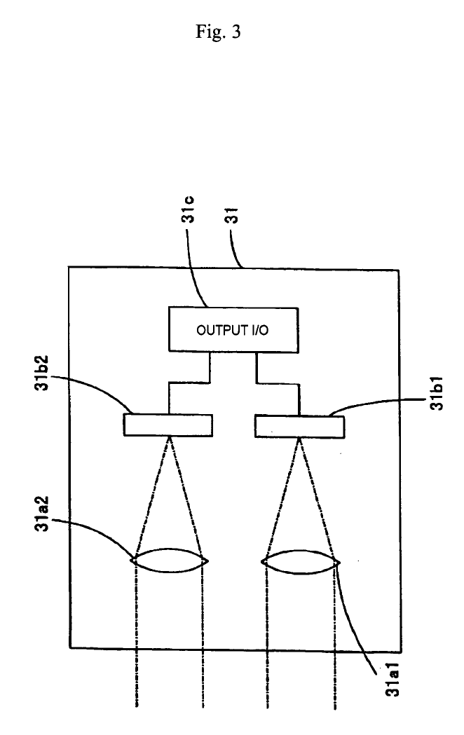

The obstacle monitoring unit 30 consists of a passive sensor unit 31 composed of ranging sensors for auto focus (hereinafter called AF) (31R, 31FR, 31FM, 31FL, 31L, 31CL); an AF sensor communication I/O 32 as a communication interface to the passive sensor unit 31; illumination LEDs 33; and an LED driver 34 to supply driving current to each LED. First, the construction of the AF passive sensor unit 31 will be described. FIG. 3 schematically shows the construction of the AF passive sensor unit 31. It includes a biaxial optical system consisting of almost parallel optical systems 31a1 and 31a2; CCD line sensors 31b1 and 31b2 disposed approximately in the image focus positions of the optical systems 31a1 and 31a2 respectively; and an output I/O 31c to output image data taken by each of the CCD line sensors 31b1 and 31b2 to the outside.

The CCD line sensors 31b1 and 31b2 each have a CCD sensor with 160 to 170 pixels and can output 8-bit data representing the amount of light for each pixel. Since the optical system is biaxial, the discrepancy between two formed images varies depending on the distance, which means that it is possible to measure a distance based on a difference between data from the CCD line sensors 31b1 and 31b2. As the distance decreases, the discrepancy between formed images increases, and vice versa. Therefore, an actual distance is determined by scanning data rows (4 to 5 pixels/row) in output image data, finding the difference between the address of an original data row and that of a discovered data row, and then referencing a difference-to-distance conversion table prepared in advance.

The AF passive sensors 31FR, 31FM, and 31FL are used to detect an obstacle in front of the cleaner while the AF passive sensors 31R and 31L are used to detect an obstacle on the right or left ahead in the immediate vicinity. The AF passive sensor 31CL is used to detect a distance up to the ceiling ahead.

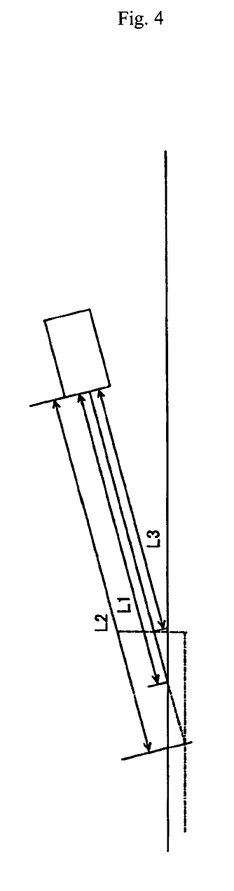

FIG. 4 shows the principle under which the AF passive sensor unit 31 detects an obstacle in front of the cleaner or on the immediate right or left ahead. The AF passive sensor unit 31 is oriented obliquely toward the surrounding floor surface. If there is no obstacle on the opposite side, the ranging distance covered by the AF passive sensor unit 31 in the almost whole imaging range is expressed by L1. However, if there is a step or floor level difference as indicated by alternate long and short dash line in the figure, the ranging distance is expressed by L2. Namely, an increase in the ranging distance suggests the presence of a step. If there is a floor level rise as indicated by alternate long and two dashes line, the ranging distance is expressed by L3. If there is an obstacle, the ranging distance is calculated as the distance to the obstacle as when there is a floor level rise, and it is shorter than the distance to the floor.

In this embodiment, when the AF passive sensor unit 31 is oriented obliquely toward the floor surface ahead, its imaging range is approx. 10 cm. Since this self-propelled cleaner has a width of 30 cm, the three AF passive sensors 31FR, 31FM and 31FL are arranged at slightly different angles so that their imaging ranges do not overlap. This arrangement allows the three AF passive sensors 31FR, 31FM and 31FL to detect an obstacle or step in a 30-cm wide area ahead of the cleaner. The detection area width varies depending on the sensor model and position, and the number of sensors should be determined according to the actually required detection area width.

Regarding the AF passive sensors 31R and 31L which detect an obstacle on the immediate right and left ahead, their imaging ranges are vertically oblique to the floor surface. The AF passive sensor 31R is mounted at the left side of the body so that a rightward area beyond the width of the body is shot across the center of the body from the immediate right and the AF passive sensor 31L is mounted at the right side of the body so that a leftward area beyond the width of the body is shot across the center of the body from the immediate left.

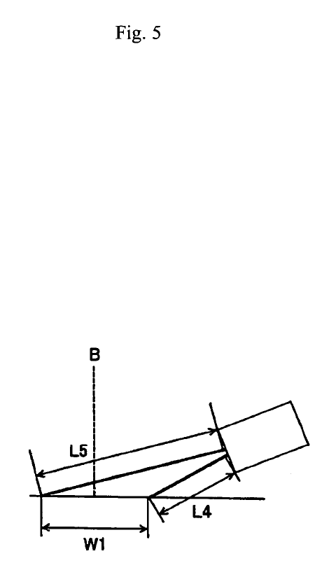

If the left and right sensors should be located so as to cover the leftward and rightward areas just before them respectively, they would have to be sharply angled with respect to the floor surface and the imaging range would be very narrow. As a consequence, more than one sensor would be needed on each side. For this reason, it is arranged that the left sensor covers the rightward area and the right sensor covers the leftward area in order to obtain a wider imaging range with a smaller number of sensors. The CCD line sensors are arranged vertically so that the imaging range is vertically oblique, and as shown in FIG. 5, the imaging range width is expressed by W1. Here, L4, distance to the floor surface on the right of the imaging range, is short and L5, distance to the floor surface on the left, is long. The imaging range portion up to the border line is used to detect a step or the like and the imaging range portion beyond the border line is used to detect a wall, where the border line of the body side is expressed by dashed line B in the figure.

The AF passive sensor 31CL, which detects a distance to the ceiling ahead, faces the ceiling. Usually, the distance from the floor surface to the ceiling which is detected by the AF passive sensor 31CL is constant but as it comes closer to a wall surface, it covers not the ceiling but the wall surface and the ranging distance becomes shorter. Hence, the presence of a wall can be detected more accurately.

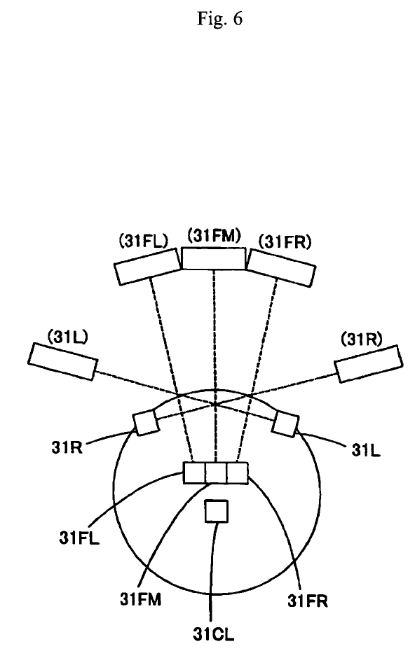

FIG. 6 shows how the AF passive sensors 31R, 31FR, 31FM, 31FL, 31L and 31CL are located on the body BD where the respective floor imaging ranges covered by the sensors are represented by the corresponding code numbers in parentheses. The ceiling imaging range is omitted here.

The cleaner has the following white LEDs: a right illumination LED 33R, a left illumination LED 33L and a front illumination LED 33M to illuminate the images from the AF passive sensors 31R, 31FR, 31FM, 31FL and 31L; and an LED driver 34 supplies a driving current to illuminate the images according to an instruction from the CPU 11. Therefore, even at night or in a dark place (under the table, etc), it is possible to acquire image data from the AF passive sensor unit 31 effectively.

The travel system unit 40 includes: motor drivers 41R, 41L; drive wheel motors 42R, 42L; and a gear unit (not shown) and drive wheels driven by the drive wheel motors 42R and 42L. A drive wheel is provided on each side (right and left) of the body BD. In addition, a free rolling wheel without a drive source is attached to the center bottom of the front side of the body. The rotation direction and angle of the drive wheel motors 42R and 42L can be accurately controlled by the motor drivers 41R and 41L which output drive signals according to an instruction from the CPU 11. From output of rotary encoders integral with the drive wheel motors 42R and 42L, the actual drive wheel rotation direction and angle can be accurately detected. Alternatively, the rotary encoders may not be directly connected with the drive wheels but a driven wheel which can rotate freely may be located near a drive wheel so that the actual amount of rotation can be detected by feedback of the amount of rotation of the driven wheel even if the drive wheel slips. The travel system unit 40 also has a geomagnetic sensor 43 so that the traveling direction can be determined according to the geomagnetism. An acceleration sensor 44 detects the acceleration velocity in the X, Y and Z directions and outputs the detection result.

Since the drive wheels must bear heavy burdens, this self-propelled cleaner uses replaceable drive wheel units to maintain satisfactory performance for an extended period. Concretely, a drive wheel motor 42R (42L), a right (left) drive wheel, and a gear unit are integrated into one unit which can be detached from, or attached to, the body.

The gear unit and drive wheels may be embodied in any form and they may use circular rubber tires or endless belts.

The cleaning mechanism in the self-propelled cleaner consists of: side brushes located forward at both sides which gather dust beside each side of the body BD in the advance direction and bring the gathered dust toward the center of the body BD; a main brush which scoops the gathered dust in the center; and a suction fan which takes the dust scooped by the main brush into a dust box by suction. The cleaning system unit 50 consists of: side brush motors 51R and 51L and a main brush motor 52; motor drivers 53R, 53L and 54 for supplying driving power to the motors; a suction motor 55 for driving the suction fan; and a motor driver 56 for supplying driving power to the suction motor. The CPU 11 appropriately controls cleaning operation with the side brushes and main brush depending on the floor condition and battery condition or a user instruction.

The camera system unit 60 has two CMOS cameras 61 and 62 with different viewing angles which are mounted on the front side of the body BD at different angles of elevation. A camera communication I/O 63 which gives the camera 61 or 62 an instruction to take a photo and outputs the photo image. In addition, it has a camera illumination LED array 64 composed of 15 white LEDs oriented toward the direction in which the cameras 61 and 62 take photos, and an LED driver 65 for supplying driving power to the LEDs.

The wireless LAN unit 70 has a wireless LAN module 71 so that the CPU 11 can be connected with an external LAN wirelessly in accordance with a prescribed protocol. The wireless LAN module 71 assumes the presence of an access point (not shown) and the access point should be connectable with an external wide area network (for example, the Internet) through a router. Therefore, ordinary mail transmission and reception through the Internet and access to websites are possible. The wireless LAN module 71 is composed of a standardized card slot and a standardized wireless LAN card to be connected with the slot. Of course other standardized cards can be connected to the card slot as well.

Next, how the above self-propelled cleaner works will be described.

(1) Traveling Control and Cleaning Operation

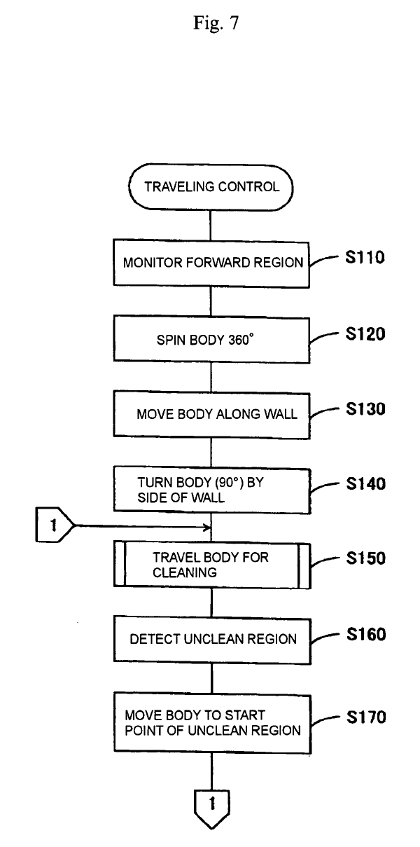

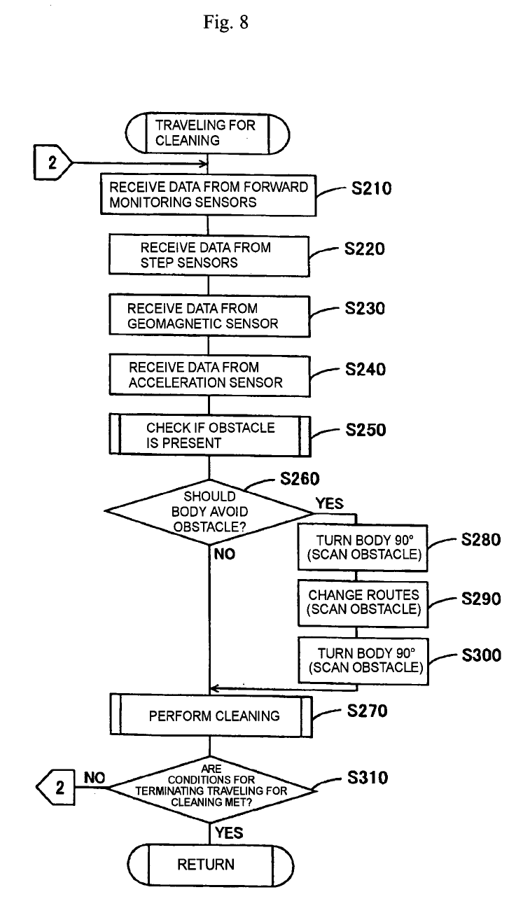

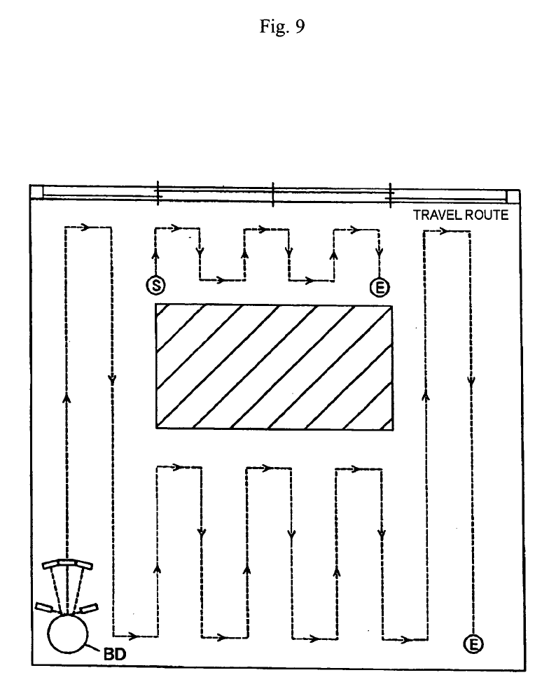

FIGS. 7 and 8 are flowcharts which correspond to a control program which is executed by the CPU 11; and FIG. 9 shows a travel route along which this self-propelled cleaner moves under the control program.

When the power is turned on, the CPU 11 begins to control traveling as shown in FIG. 7. At step S110, it receives the results of detection by the AF passive sensor unit 31 and monitors a forward region. In monitoring the forward region, reference is made to the results of detection by the AF passive sensors 31FR, 31FM and 31F; and if the floor surface is flat, the distance L1 to the floor surface (located downward in an oblique direction as shown in FIG. 4) is obtained from an image thus taken. Whether the floor surface in the forward region corresponding to the body width is flat or not is decided based on the results of detection by the AF passive sensors 31FR, 31FM and 31FL. However, at this moment, no information on the space between the body's immediate vicinity and the floor surface regions facing the AF passive sensors 31FR, 31FM and 31FL is not obtained so the space is a dead area.

At step S120, the CPU 11 orders the drive wheel motors 42R and 42L to rotate in different directions by equal amount through the motor drivers 41R and 41L respectively. As a consequence, the body BD begins turning on the spot. The rotation amount of the drive motors 42R and 42L required for 360-degree turn on the same spot (spin turn) is known and the CPU 11 informs the motor drivers 41R and 41L of that required rotation amount.

During this spin turn, the CPU 11 receives the results of detection by the AF passive sensors 31R and 31L and judges the condition of the immediate vicinity of the body BD. The above dead area is almost covered (eliminated) by the results of detection obtained during this spin turn, and if there is no step or obstacle there, it is confirmed that the surrounding floor surface is flat.

At step 130, the CPU 11 orders the drive wheel motors 42R and 42L to rotate by equal amount through the motor drivers 41R and 41L respectively. As a consequence, the body begins moving straight ahead. During this straight movement, the CPU 11 receives the results of detection by the AF passive sensors 31FR, 31FM and 3FL and the body advances while checking whether there is an obstacle ahead. The above dead area is almost covered by the detection made during this spin turn. When a wall surface as an obstacle ahead is detected, the body stops a prescribed distance short of the wall surface.

At step S140, the body turns clockwise by 90 degrees. The prescribed distance short of the wall at step S130 corresponds to a distance that the body BD can turn without colliding the wall surface and the AF passive sensors 31R and 31L can monitor their immediate vicinity and rightward and leftward regions beyond the body width. In other words, the distance should be such that when the body turns 90 degrees at step S140 after it stops according to the results of detection by the AF passive sensors 31FR, 31FM and 31FL at step S130, the AF passive sensor 31L can at least detect the position of the wall surface. Before it turns 90 degrees, the condition of its immediate vicinity should be judged according to the results of detection by the AF passive sensors 31R and 31L. FIG. 9 is a plan view which shows the cleaning start point (in the left bottom corner of the room as shown) which the body has thus reached.

There are various other methods of reaching the cleaning start point. If the body should turn only clockwise 90 degrees in contact with the wall surface, cleaning would begin midway on the first wall. If the body reaches the optimum position in the left bottom corner as shown in FIG. 9, it is also desirable to control its travel so that it turns counterclockwise 90 degrees in contact with the wall surface and advances until it touches the front wall surface, and upon touching the front wall surface, it turns 180 degrees.

At step S150, the body travels for cleaning. FIG. 8 is a flowchart which shows cleaning traveling steps in detail. Before advancing or moving forward, the CPU 11 receives the results of detection by various sensors at steps S210 to S240. At step S210, it receives forward monitoring sensor data (specifically the results of detection by the AF passive sensors 31FR, 31FM, 31FL and 31CL) which is used to judge whether or not there is an obstacle or wall surface ahead in the traveling area. Forward monitoring here includes monitoring of the ceiling in a broad sense.

At step S220, the CPU 11 receives step sensor data (specifically the results of detection by the AF passive sensors 31R and 31L) which is used to judge whether or not there is a step in the immediate vicinity of the body in the traveling area. Also, while the body BD moves along a wall surface or obstacle, the distance to the wall surface or obstacle is measured in order to judge whether or not it is moving in parallel with the wall surface or obstacle.

At step 230, the CPU 11 receives geomagnetic sensor data (specifically the result of detection by the geomagnetic sensor 43) which is used to judge whether or not there is any change in the traveling direction of the body which is moving straight. For example, the angle of geomagnetism at the cleaning start point is memorized and if an angle detected during traveling is different from the memorized angle, the amounts of rotation of the left and right drive wheel motors 42R and 42L are slightly differentiated to adjust the traveling direction to restore the original angle. If the angle becomes larger than the original angle of geomagnetism (change from 359 degrees to 0 degree is an exception), it is necessary to adjust the traveling direction to make it more leftward. Hence, an instruction is given to the motor drivers 41R and 41L to make the amount of rotation of the right drive wheel motor 42R slightly larger than that of the left drive wheel motor 42L.

At step S240, the CPU 11 receives acceleration sensor data (specifically the result of detection by the acceleration sensor 44) which is used to check the traveling condition. For example, if an acceleration in substantially one direction is sensed at the start of rectilinear traveling, the traveling is recognized to be normal. If acceleration in a varying direction is sensed, an abnormality that one of the drive wheel motors is not driven is recognized. If detected acceleration velocity is out of the normal range, a fall from a step or an overturn is suspected. If considerable backward acceleration is detected, collision against an obstacle ahead is suspected. Although there is no direct acceleration control function (for example, a function to keep a desired acceleration velocity by input of an acceleration value or achieve a desired acceleration velocity based on integration), acceleration data is effectively used to detect an abnormality.

At step S250, the system check whether there is an obstacle according to the results of detection by the AF passive sensors 31FR, 31FM, 31CL, 31FL, 31R and 31L which the CPU 11 have received at steps S210 and S220. This check is made for each of the forward regions, ceiling and immediate vicinity. Here the forward region refers to an area ahead where detection is made for an obstacle or wall surface; and the immediate vicinity refers to an area where detection for a step is made and the condition of regions on the left and right of the body beyond the traveling width is checked (presence of a wall, etc). The ceiling here refers to an area where detection is made, for example, for a door lintel underneath the ceiling which leads to a hall and might cause the body to go out of the room.

At step S260, the system evaluates the results of detection by the sensors comprehensively to decide whether to avoid an obstacle or not. As far as there is no obstacle to be avoided, a cleaning process at step S270 is carried out. The cleaning process refers to a process that dust is sucked in while the side brushes and main brush are rotating. Concretely, an instruction is issued to the motor drivers 53R, 53L, 54 and 56 to drive the motors 51R, 51L, 52 and 55. Obviously the same instruction is always given during traveling and when the conditions to terminate cleaning traveling are met, the body stops traveling.

While cleaning is under way, the elapsed time and traveled distance are accumulated or totalized. For accumulation of elapsed time, the time of issuance of a command to drive the motor drivers 53R, 53L, 54 and 56 and the time of issuance of a command to stop them are recorded in a given nonvolatile memory area as a log. Although this method does not directly calculate the cumulative duration of use, elapsed time is totalized by access to the log when referring to cumulative duration. It is also possible to update the cumulative duration at every log output. Traveled distances are totalized according to rotary encoder output. Since the data volume of rotary encoder output is too much to be stored as a log, distance is accumulated each time output is obtained. Distances of forward movement and backward movement are accumulated in the same way. The cumulative duration of use and the cumulative traveled distance can be used later to know how much the side brushes and main brush have been used.

On the other hand, if it is decided that the body must avoid an obstacle (do escape motion), it turns clockwise 90 degrees at step S280. This is a 90-degree turn on the same spot which is achieved by giving an instruction to the drive wheel motors 42R and 42L through the motor drivers 41R and 41L respectively to turn them in different directions by the amount necessary for the 90-degree turn. Here, the right drive wheel should turn backward and the left drive wheel should turn forward. During the turn, the CPU 11 receives the results of detection by the AF passive sensors 31R and 31L as step sensors and checks for an obstacle. When an obstacle ahead is detected and the body turns clockwise 90 degrees, if the AF passive sensor 31R does not detect a wall ahead on the right in the immediate vicinity, it may be considered to have simply touched a forward wall, but if a wall surface ahead on the right in the immediate vicinity is still detected even after the turn, the body may be considered to get caught in a corner. If neither of the AF passive sensors 31R and 31L detects an obstacle ahead in the immediate vicinity during 90-degree turn, it can be thought that the body has not touched a wall but there is a small obstacle.

At step S290, the body advances to change routes or turn while scanning for an obstacle. It touches the wall surface and turns clockwise 90 degrees, then advances. If it has stopped short of the wall, the distance of the advance is almost equal to the body width. After advance by that distance, the body turns clockwise 90 degrees again at step S300.

During the above movement, the forward region and leftward and rightward regions ahead are always scanned for an obstacle and the result of this monitoring scan is memorized as information on the presence of an obstacle in the room.

As explained above, a 90-degree clockwise turn is made twice. If the body should turn clockwise 90 degrees upon detection of a next wall ahead, it would return to its original position. Therefore, after it turns clockwise 90 degrees twice, it should turn counterclockwise twice and then clockwise twice, namely in alternate directions. This means that it should turn clockwise at an odd-numbered time of escape motion and counterclockwise at an even-numbered time of escape motion. The system continues traveling for cleaning while scanning the room in a zigzag pattern and avoiding an obstacle as described so far. Then at step S310, whether or not it has reached the end of the room is decided. After the second turn, if the body has advanced along the wall and has detected an obstacle ahead, or if it has entered a region where it already traveled, it is decided that the body has reached the cleaning traveling termination point. In other words, the former situation can occur after the last end-to-end travel in the zigzag movement; and the latter situation can occur when a region left unclean is found and cleaning traveling is started again.

If neither of these conditions is met, the system goes back to step S210 and repeats the abovementioned steps. If one of the conditions is met, the system finishes the cleaning traveling subroutine and returns to the process of FIG. 7.

After returning to the process of FIG. 7, at step S160, the system judges from the collected information on the traveled regions and their surroundings as to whether or not there is any region left unclean. Various known methods of detection for an unclean region are available. One of such methods is to map regions traveled so far and store information on them. In this example, based on the abovementioned rotary encoder detection results, the travel route or traveled regions in the room and information on wall surfaces detected during traveling are written in a map reserved in a memory area. The presence of an unclean region is determined from the map by checking whether or not, in the map, the surrounding wall surface is continuous and the regions around obstacles in the room are all continuous and the body has traveled across all regions of the room except the obstacles. If an unclean region is found, the body BD moves to the start point of the unclean region at step S170 and the system returns to step S150 and starts cleaning traveling again.

Even if there are several unclean regions here and there, each time the conditions to terminate cleaning traveling is met, detection for an unclean region is repeated as described above until there is no unclean region.

(2) Self-Diagnosis Function

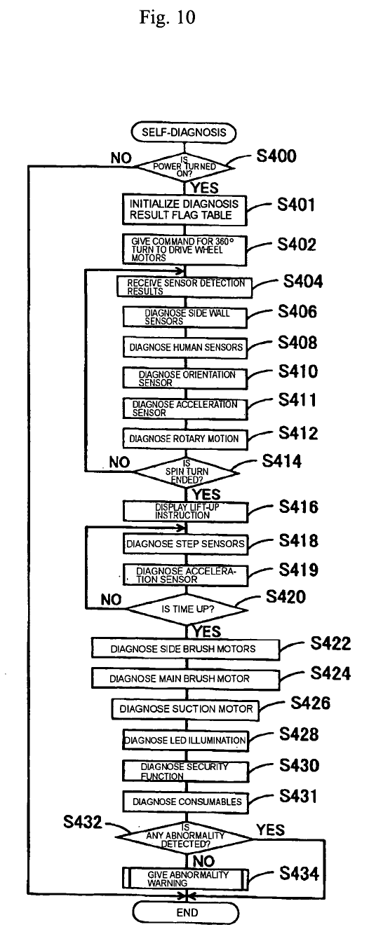

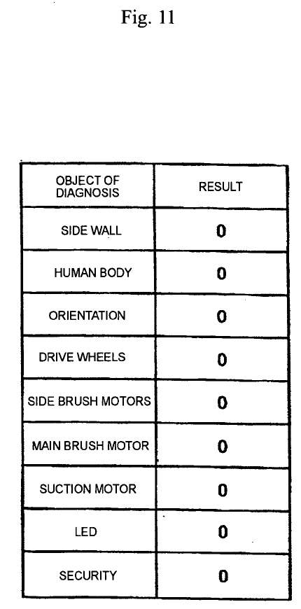

FIG. 10 is a flowchart showing a self-diagnosis process executed by the CPU 11 and FIG. 11 shows a diagnosis result flag table in which diagnosis results are written as flags.

The self-diagnosis process is started when the user turns on the power with the body BD beside a wall.

First, the CPU 11 decides whether the power has been just turned on or not (step S400). It is enough to execute the self-diagnosis process only once after the power is turned on. Hence, the purpose of this decision at step S400 is to avoid repeating the steps described next. For example, it is arranged that when the following steps have been taken, a given flag should be set; unless this flag is set, the CPU 11 decides that the system has been started for the first time, and carries out the steps described next. At step S401, the CPU 11 initializes the diagnosis result flag table, namely writes the initial value “0” in the table.

At step S402, the CPU 11 orders the drive wheel motors to spin the body BD 360 degrees. Concretely, it gives the motor drivers 41R and 41L a command concerning the amount of motor rotation in different directions required for 360-degree turn, and the motor drivers 41R and 41L supply driving power to the drive wheel motors 42R and 42L respectively. While the body is rotating 360 degrees according to this command, the CPU 11 repeats steps S404 to S414.

At step S404, the CPU 11 receives the results of detection by the sensors. At step S406, side wall sensors are diagnosed. The AF passive sensors 31R, 31FR, 31FM, 31FL, 31L and 31CL serve as side sensors which detect for an obstacle beside the body BD. These sensors cover regions not only beside the body BD but also ahead and a ranging distance to the ceiling. These sensors are used to check for a wall surface around the body and thus can be used to detect for an obstacle beside the body in a broad sense. During 360-degree turn, the CPU 11 receives the results of detection by the AF passive sensors 31R, 31FR, 31FM, 31FL, 31L and 31CL and, if change in each detection result is within the range of change as expected of turn of the body BD beside a wall surface, decides that there is no abnormality. On the contrary, if no wall surface is detected, it decides that there is an abnormality. For example, during one full turn of the body, the front AF passive sensors 31FR, 31FM and 31FL should face an adjacent wall surface and the ranging distance at this time is shorter than their usual ranging distance to the floor surface. For the AF passive sensors 31R and 31L which are used as step sensors, their coverage varies during one full turn; at times their ranging distance covers only the floor surface and at other times it covers the floor surface and some wall surface. The AF passive sensor 31CL, which faces the ceiling ahead, faces an upper part of the wall surface while the front of the body BD faces the wall surface, and faces the ceiling while the wall surface is behind the body BD; thus its ranging distance changes during one full turn. Depending on these changes, the CPU 11 decides whether the sensors (side sensors) function normally or not.

At step S408, human sensors are diagnosed. The CPU 11 checks for any abnormality in the results of detection by the human sensors 21fr, 21rr, 21fl and 21rl. Since the user turned on the power with the body BD beside the wall surface, the human sensors 21fr, 21rr, 21fl and 21rl should each face the user once and output the results of detection of the human body while the body BD is turning 360 degrees. If they never detect the human body during the full turn, they are diagnosed as out of order.

At step S410, an orientation sensor is diagnosed. The body BD has a geomagnetic sensor 43 to detect its orientation and during one full turn thereof, the angle detected by the geomagnetic sensor should also change 360 degrees. If it does not change 360 degrees, the sensor is diagnosed as out of order.

At step S411, the acceleration sensor 44 is diagnosed. Unless the acceleration sensor 44 is aligned with the rotation axis of the body BD, the acceleration sensor 44 should detect acceleration in the X and Y directions during one full turn of the body BD. If no result of detection in the X and Y directions is obtained, the sensor is diagnosed as out of order.

At step S412, the rotary motion is diagnosed. As mentioned above, the drive wheel motors 42R and 42L rotate according to output of the rotary encoder integral with them and encoder output should gradually change. If a command for rotary motion is given but there is no change in encoder output, the rotary encoder or drive wheel unit is diagnosed as out of order.

In order to ensure that the above checks are repeated until the 360-degree spin turn is ended, a decision is made as to whether the 360-degree turn is finished (step S414).

As mentioned above, a 360-degree spin turn is used to diagnose the functions of the side sensors in a broad sense, the orientation sensor and the rotary encoders.

Next, a message which tells the user to lift up the body BD appears on the liquid crystal display panel 15b (step 416). Immediately after that, the step sensors are diagnosed (step S418). The AF passive sensors 31R and 31L serve as step sensors. When the user lifts up the body, the imaging range of the AF passive sensors 31R and 31L provides a ranging distance remoter than their usual ranging distance to the floor surface. At step S419, the acceleration sensor 44 is diagnosed. When the body BD is lifted up, the acceleration sensor 44 should output the result of detection in the Z direction. If it does not output the result of detection in the Z direction, it is diagnosed as out of order.

At step S420, the CPU 11 judges whether time runs out, in order to ensure that steps S418 and S419 are repeated for a predetermined time period.

The basic functions of the drive mechanism have been checked with the above procedure.

Next, various motors used in the cleaning mechanism will be diagnosed at steps S422 to S426. The explanation below assumes that FG pulse generators are provided to detect rotations of the following motors. At step S422, in order to diagnose the side brush motors 51R and 51L, the CPU 11 gives the motor drivers 53R and 53L a command to drive the motors and receives output from the FG pulse generator (not shown). If no FG pulses are generated despite the command to drive the motors, the motors are diagnosed as out of order. Main brush motor diagnosis (step S424) and suction motor diagnosis (step S426) are carried out in the same way as above: the CPU 11 gives the motor drivers 54 and 56 a command to drive the motors and receives output from the FG pulse generators built in the main brush motor 52 and suction motor 55 to check for abnormality, respectively.

At step 428, LEDs are diagnosed. The system orders the LED drivers 34 and 65 to turn on the LEDs and checks for a battery voltage drop to see whether the LEDs are lit.

Here, the LEDs themselves are diagnosed by checking whether the battery voltages drop or not as the LEDs turn on and off. Also, the battery voltage is measured with the motors and LEDs off. For diagnosis of a battery, it is useless to measure the voltage of the battery as exhausted; therefore, a flag is set upon completion of its charging and the voltage is measured while the flag is on. The degree of exhaustion of the battery is determined from the voltage of the battery in its fully charged state. Another possible approach is to count charges made and decide that the battery has been exhausted when the number of charges exceeds a preset number.

At step S430, the security function is diagnosed. In this embodiment, the security function is provided by the camera system unit 60 and the wireless LAN unit 70. These units each have a self-check function and the CPU 11 makes them carry out a self-check and acquires the results of self-checks. Alternatively, the CPU 11 may control them individually to diagnose them whenever possible. For diagnosis of the camera system unit 60, it makes the camera system unit 60 take a photo to acquire a first photo image, then turns the body to acquire a second photo image; if there is a difference between the first and second image data, the camera system unit 60 is considered to be functioning normally. For diagnosis of the wireless LAN unit 70, dummy data is sent through a wireless LAN to be written in a given server area before the area is read. If the written data agrees with the read data, the wireless LAN unit 70 is considered to be functioning normally.

At step S431, consumables are diagnosed. In this embodiment, the battery (rechargeable), brushes and drive wheel units are diagnosed as consumables. As described above, for the rechargeable battery, its voltage in the fully charged state or the number of charges made so far is compared with reference values to decide the necessity for replacement. For the brushes, the cumulative duration of use and the cumulative distance traveled as mentioned above are compared with reference values to decide the necessity for replacement. For the drive wheel units, the necessity for replacement is decided based on rotary encoder output related to rotary motion (step S412). The results of diagnosis at step S431 are recorded not in a diagnosis result flag table (stated later) but in a consumables table in a separate nonvolatile storage area.

If at any of the above diagnosis steps it is decided that there is an abnormality, “1” is set in a corresponding cell of the diagnosis result flag table as shown in FIG. 11. Then, at step S432, referring to the table, a decision is made as to whether an abnormality has been detected or not; if an abnormality has been detected, a warning of the abnormality is given at step S434.

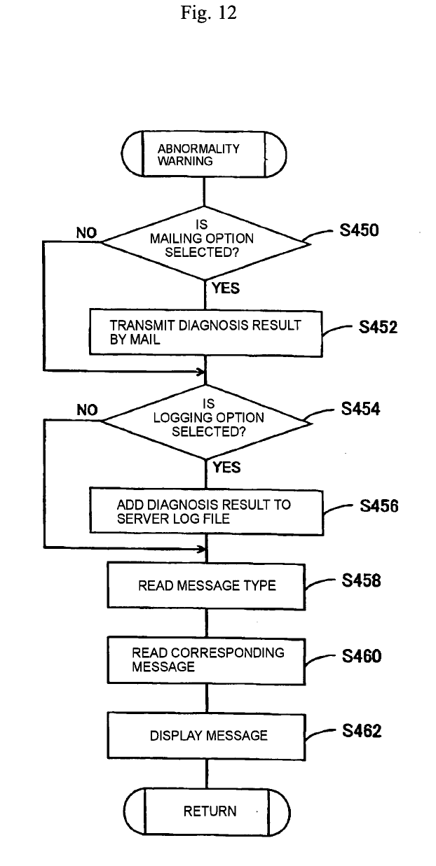

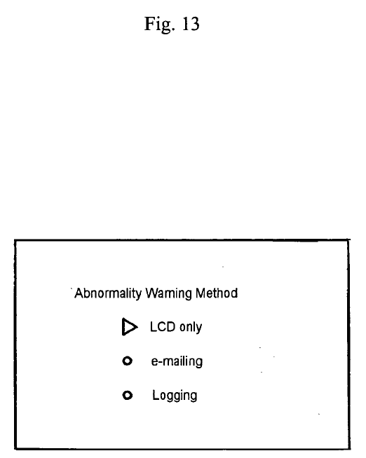

FIG. 12 is a flowchart showing an abnormality warning process which the CPU 11 executes and FIG. 13 shows a window for selection of an abnormality warning method on the liquid crystal display panel 15b.

In addition to a warning on the liquid crystal display panel 15b, available warning options are transmission by e-mail and storage in a log file in a give server area. Either of these options is selected using an operation switch 15a (not shown).

At step S450, the CPU 11 decides whether the e-mail option has been selected or not and if so, the result of diagnosis is sent by e-mail at step S452.

At step S454, the CPU 11 decides whether the logging option has been selected or not and if so, the result of diagnosis is sent to a log file at step S456.

In this embodiment, whenever an abnormality warning is to be given, a warning message is always shown on the liquid crystal display panel 15b after a message type is read at step S458.

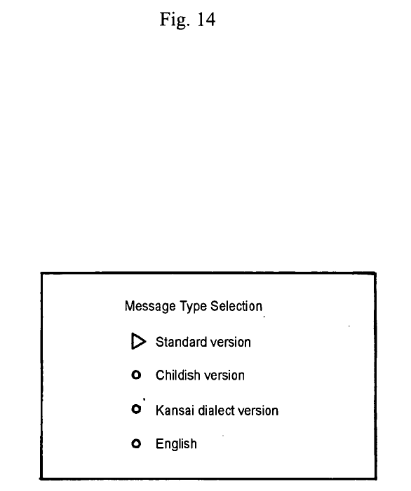

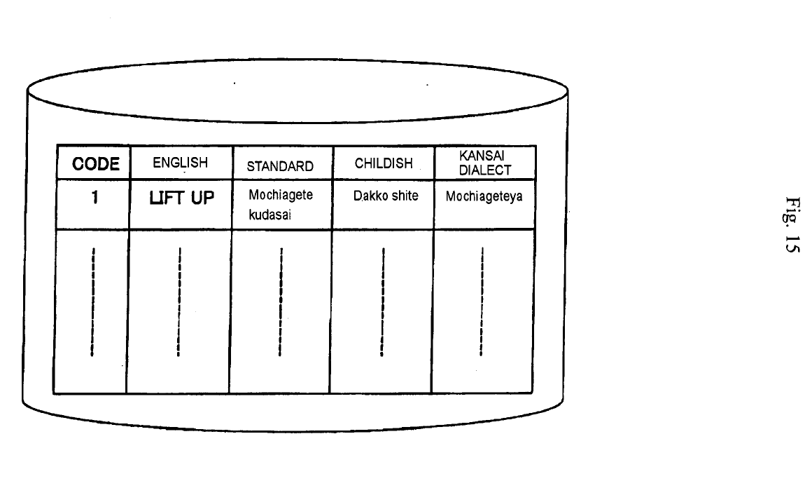

This self-diagnosis process is programmed so as to allow selection of the type of a message which appears on the liquid crystal display panel 15b. Specifically, the user can choose one from several message type options in a selection window shown in FIG. 14: “standard version”, “childish version”, “Kansai dialect version” and “English version.” FIG. 15 shows the contents of a table which stores messages by type. The table stores different types (versions) of message expressions which convey one message content. Code numbers are assigned to different messages. After a message content is determined depending on the situation, a code (number) is assigned to the message content. Then, the selected message type is read and reference is made to the table. At step S458, a previously selected message type is read and at step S460, a message expression to be actually shown is read from the table according to the code of the message content which corresponds to the diagnosis result and the selected message type. After that, the message thus read appears on the liquid crystal display panel 15b and the abnormality warning process and the self-diagnosis process are ended (step S462).

It is needless to say that when no abnormality is found at step S432, the self-diagnosis process is ended without abnormality warning.

(3) Automatic Ordering Function

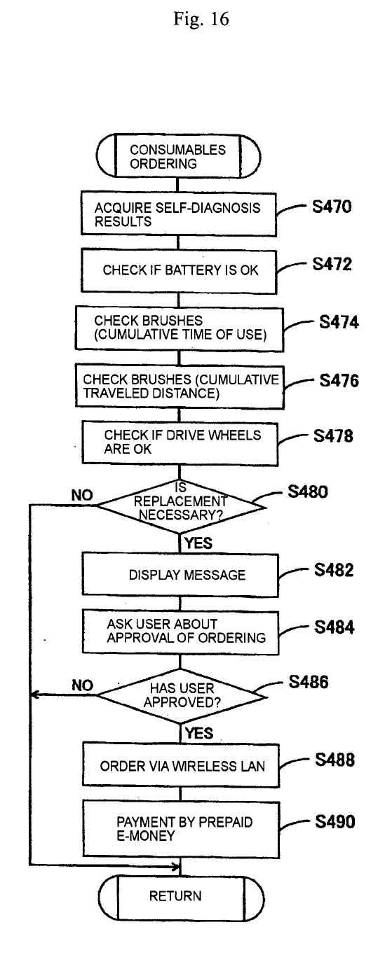

FIG. 16 is a flowchart showing a process for automatic ordering according to the results of diagnosis of consumables in the above self-diagnosis process.

The CPU 11 executes this consumable ordering process at predetermined intervals. The intervals need not be so strict; the process may be executed at each time of power input or every few times of power input or at regular intervals (for example, 24 hours). The CPU 11 acquires the results of self-diagnosis at step S470. The results of self-diagnosis acquired here are those recorded in the consumables table at step S431 in the self-diagnosis process. At step S472, whether the rechargeable battery is OK or not is checked; and whether the side brushes and main brush need be replaced or not is decided based on the cumulative duration of use (step S474) and then based on the cumulative distance traveled during their use (step S476) and whether the drive wheel units are working normally is decided based on the result of their diagnosis (step S478).

In this embodiment, the consumables are checked twice (step S431 and steps S472 to S478), which contributes to improvement in reliability. In double check, it is possible to make a comparison with reference values at the first check and have the diagnosis reflect the learning result at the second check. Obviously it is acceptable to do only either of the first and second checks.

At step S480, whether replacement is necessary is decided according to the decisions made at steps S472 to S478. If no replacement is necessary, the consumables ordering process is ended. If it is necessary to replace a certain consumable component, a message asking the user whether to order or not is shown at step S482.

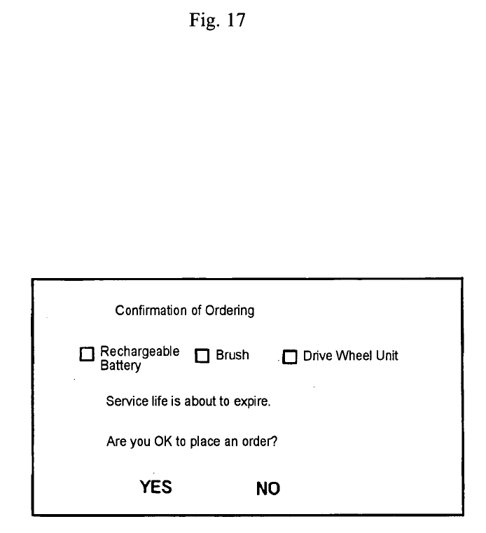

FIG. 17 shows an example of a message window for asking the user whether to order or not, which appears on the liquid crystal display panel 15b. This window contains the names of the consumables and allows the user to choose whether to order or not using the operation switch 15a. There are checkboxes next to the words “rechargeable battery,” “brush” and “drive wheel unit” and the checkbox next to the consumable component which should be replaced is automatically checked. The user can check a checkbox except the automatically checked one, for example, in order to save the shipping charge by bulk ordering. Alternatively, fields for entry of the quantity of order may be provided in place of the checkboxes.

Since the user does not always want to order consumables, the user's decision is confirmed (step S486) and only when the user accepts ordering, an order is automatically placed through a wireless LAN (step 488). Concretely, through the wireless LAN and the Internet, a preset website for ordering is accessed and ordering information is transmitted. At this website, which allows entry of the owner of a self-propelled cleaner, the owner is identified by their cleaner's serial number and MAC address so that consumables ordered are shipped to a specified address.

Automatically ordered consumables are not shipped unless payment for the order is guaranteed. At step S490, payment is made by prepaid electronic money. Prepaid electronic money is a system in which the user previously made payment to a prescribed institution and makes payment for the order through the institution subject to verification.

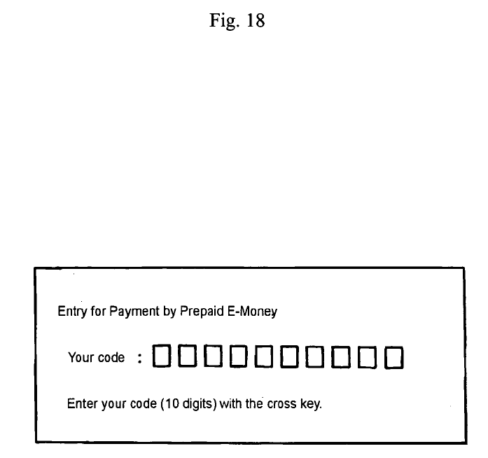

FIG. 18 shows an entry window on the liquid crystal display panel 15b for payment by prepaid electronic money. The institution to which the user made payment gives the user a verification code of ten digits or so and the user enters this verification code into their self-propelled cleaner in advance. At step S490, this code is encrypted and sent to a consumables supplier. The supplier asks the institution about the authenticity of the code and confirms that the user's deposit balance is larger than the payable amount. As a consequence, when the balance is found to be larger than the payable amount, the institution guarantees the payment and the supplier can ship the order safely.

In the embodiment explained so far, the self-propelled cleaner directly places an order through the wireless LAN. However, the user may wish to place an order through their computer. In order to meet this need, it may be arranged that necessary information is sent to their computer through the wireless LAN so that the user can reorder through the computer based on the received information.

Various types of prepaid electronic money are available and any type other than the abovementioned type may be adopted.

As described so far, based on the results of a series of self-diagnosis steps (step S400 and subsequent steps) and the cumulative duration of use and the cumulative traveled distance as accumulated during daily cleaning operations (step 270), the CPU 11 judges the necessity for an order for a replacement (steps S431 and S427 to S478) and if ordering is necessary, it asks the user for approval of ordering (steps S482 and S484) and through a wireless LAN, an order is placed and payment is made by prepaid electronic money (steps S488 and S490). Therefore, the system's automatic ordering function can be used conveniently in the home where consumable stock management is impossible.

According to the present invention, it is possible to provide a self-propelled cleaner which automatically orders consumables as needed in combination with the function of self-diagnosis.

1. A self-propelled cleaner having a body with a cleaning mechanism with a rechargeable battery for cleaning with brushes, and a drive mechanism with replaceable drive wheel units at the left and right sides of the body which can be individually controlled for steering and driving the cleaner, comprising:
a wireless LAN communication device which can transmit information to the outside and receive information from the outside through a wireless LAN;
a self-diagnosis processor which conducts self-checks including judgment about the condition of the rechargeable battery and judgment about the condition of the brushes based on the cumulative duration of use of the brushes and the cumulative distance traveled during their use; and
a consumables ordering control processor which, based on the results of self-diagnosis, checks the rechargeable battery for exhaustion and the brushes for wear, based on the cumulative duration of use of the brushes and the cumulative traveled distance, checks the drive wheels for abnormality and determines which consumables should be replaced, asks the user to decide whether to order or not and makes the wireless LAN communication device place an order.

2. A self-propelled cleaner having a body with a cleaning mechanism, and a drive mechanism capable of steering and driving the cleaner, comprising:
a wireless LAN communication device which can transmit information to the outside and receive information from the outside through a wireless LAN;
a self-diagnosis processor which conducts self-checks; and
a consumables ordering control processor which determines, based on the results of self-diagnosis, which consumables should be replaced and makes the wireless LAN communication device place an order.

3. The self-propelled cleaner as described in claim 2, wherein the ordering control processor asks the user to decide whether to order or not before ordering through the wireless LAN communication device.

4. The self-propelled cleaner as described in claim 3, wherein, in asking the user to decide whether to order or not, the names of consumables are shown and the user can choose whether to order or not and also order a consumable other than the consumable to be replaced.

5. The self-propelled cleaner as described in claim 4, wherein the user can specify the quantity of order.

6. The self-propelled cleaner as described in claim 2, wherein the body has a rechargeable battery; the self-diagnosis processor diagnoses the condition of the rechargeable battery; and, if the self-diagnosis processor finds based on the results of self-diagnosis that the rechargeable battery is exhausted, the consumables ordering control processor makes the wireless LAN communication device order a replacement for the battery.

7. The self-propelled cleaner as described in claim 2, wherein the cleaning mechanism in the body has brushes for cleaning; the self-diagnosis processor can suggest wear of a brush; and if the self-diagnosis processor suggests wear of the brushes based on the results of self-diagnosis, the consumables ordering control processor makes the wireless LAN communication device order replacements for the brushes.

8. The self-propelled cleaner as described in claim 7, wherein the self-diagnosis processor measures with a timer and accumulates the duration of use of the brushes and suggests wear of the brushes when a prescribed cumulative duration of use is exceeded.

9. The self-propelled cleaner as described in claim 7, wherein the self-diagnosis processor accumulates the distances traveled during use of the brushes and suggests wear of the brushes when a prescribed cumulative traveled distance is exceeded.

10. The self-propelled cleaner as described in claim 2, wherein the drive mechanism is a replaceable unit and, if the self-diagnosis processor finds based on the results of self-diagnosis that the drive mechanism is out of order, the ordering control processor orders a replacement for the drive mechanism as a unit.

11. The self-propelled cleaner as described in claim 2, wherein the ordering control processor allows payment for an order by prepaid card electronic money.

12. The self-propelled cleaner as described in claim 11, wherein a verification code which is given the user when the user makes payment to a prescribed institution is entered into the self-propelled cleaner in advance and the code is encrypted and sent to a consumables supplier.

13. The self-propelled cleaner as described in claim 2, wherein the self-diagnosis processor makes a double check to improve reliability.

14. The self-propelled cleaner as described in claim 13, wherein in double check, comparison with a reference value is made in the first check and the result of learning is reflected in diagnosis at the second check.
